(19) United States
(12) Patent Application Publication
(10) Pub. No.: US 2019/0371173 A1
(43) Pub. Date: Dec. 5, 2019

(54) VEHICLE TERMINAL AND OPERATION METHOD THEREOF

(71) Applicant: LG Electronics Inc., Seoul (KR)

(72) Inventor: Changhun SUNG, Seoul (KR)

(21) Appl. No.: 16/545,856

(22) Filed: Aug. 20, 2019

(30) Foreign Application Priority Data
Jul. 11, 2019 (KR) 10-2019-0083996

(51) Int. Cl. G08G 1/0967; H04W 4/46; H04W 4/44; G08G 1/01

(52) U.S. Cl. CPC G08G 1/096791; G08G 1/0112; H04W 4/44; H04W 4/46

(57) ABSTRACT

Disclosed is a method of identifying whether or not an abnormally congested section has occurred in a road section and providing information on the abnormally congested section and a vehicle terminal for the same. One or more of a vehicle, a vehicle terminal, and an autonomous vehicle disclosed here is connectable to, for example, an artificial intelligence module, an unmanned aerial vehicle (UAV), a robot, an augmented reality (AR) device, a virtual reality (VR) device, or a 5G service device.

### CROSS-REFERENCE TO RELATED APPLICATION

This application is based on and claims priority under 35 U.S.C. § 119(a) to Korean Patent Application No. 10-2019-0083996, which was filed on Jul. 11, 2019, in the Korean Intellectual Property Office, the disclosure of which is incorporated herein in its entirety by reference.

### BACKGROUND

### 1. Field

The present disclosure relates to a vehicle terminal and an operation method thereof. More particularly, the present disclosure relates to a vehicle terminal which provides information on an abnormally congested section and an operation method thereof.

### 2. Description of the Related Art

Due to accidents, drunk driving control, a group of successive vehicles, constructions, and emergency vehicle traffic, for example, an abnormally congested section may suddenly occur. Traffic information provided by a server, however, has difficulty in reflecting the abnormally congested section which suddenly occurs since it has a relatively long update time interval. Therefore, there is a need to detect the occurrence of such an abnormally congested section more quickly and to provide information on the abnormally congested section.

In addition, an autonomous vehicle refers to a vehicle equipped with an autonomous driving device which is capable of recognizing the environment around the vehicle and the vehicle condition and thus, controlling the driving of the vehicle. With the progress of autonomous vehicle researches, various services which may increase user convenience using an autonomous vehicle are also being studied.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments disclosed here are devised to provide a vehicle terminal and an operation method thereof. Technical subjects to be achieved by the embodiments are not limited to the above-described technical subject, and other technical subjects may be analogized from the following embodiments.

An operation method of a vehicle terminal according to one embodiment of the present disclosure includes acquiring traffic information on a road section from a server and acquiring information on a driving speed of a peripheral vehicle from the peripheral vehicle that is driving the road section, identifying whether or not an abnormally congested section has occurred in the road section by determining a traffic speed of the road section based on the traffic information and comparing the traffic speed of the road section with the driving speed of the peripheral vehicle, and providing information on the abnormally congested section when it is identified that the abnormally congested section has occurred in the road section.

A vehicle terminal according to another embodiment includes a communication unit, and a controller configured to acquire traffic information on a road section from a server and acquire information on a driving speed of a peripheral vehicle from the peripheral vehicle that is driving the road section through the communication unit, to identify whether or not an abnormally congested section has occurred in the road section by determining a traffic speed of the road section based on the traffic information and comparing the traffic speed of the road section with the driving speed of the peripheral vehicle, and to provide information on the abnormally congested section through the communication unit when it is identified that the abnormally congested section has occurred in the road section.

A computer readable recording medium according to a further embodiment includes a non-volatile recording medium storing a program for executing the above-described method in a computer.

Details of other embodiments are included in the following detailed description and the drawings.

Embodiments of the present disclosure provide one or more of the following effects.

First, a vehicle terminal may more quickly grasp whether or not an abnormally congested section has occurred in a road section. For example, traffic information on a road section, which is provided from a server, may be updated at a time interval of about 30 minutes or 1 hour. On the other hand, the vehicle terminal may more quickly identify whether or not an abnormally congested section has occurred based on traffic information on a road section and the driving speed of a peripheral vehicle, and may provide the identified result to the outside to contribute to smooth vehicle traffic.

Second, information indicating that an abnormally congested section has occurred may be provided from a server to a vehicle, which enables construction of a broader traffic information transfer system. For example, since the range of vehicle-to-vehicle communication is limited, whereas the range of server-to-vehicle communication is relatively wide, information indicating that an abnormally congested section has occurred may be transferred to vehicles within a broader area through a server.

Effects of the present disclosure are not limited to the effects mentioned above, and other unmentioned effects may be clearly understood by those skilled in the art from a description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate examples of an autonomous vehicle operation using 5G communication.

FIG. 7 illustrates an example of a basic operation of a first autonomous vehicle and a second autonomous vehicle in a 5G communication system.

FIG. 8 illustrates an embodiment in which a 5G network is directly concerned in the resource allocation of signal transmission and reception in 5G communication between autonomous vehicles.

FIG. 9 illustrates an embodiment in which a 5G network is indirectly concerned in the resource allocation of signal transmission and reception in 5G communication between autonomous vehicles.

FIG. 10 is a view illustrating an example of an operation of a vehicle terminal.

FIG. 11 is a flowchart of an operation method of a vehicle terminal.

FIG. 12 illustrates an embodiment in which a vehicle terminal determines the traffic speed of a road section.

FIG. 13 illustrates an embodiment in which a vehicle terminal identifies whether or not an abnormally congested section has occurred in a road section.

FIG. 14 illustrates an embodiment in which a vehicle identifies, for each lane, whether or not an abnormally congested section has occurred in a road section.

FIG. 15 illustrates an embodiment in which a vehicle transmits information on an abnormally congested section to a server.

FIG. 16 illustrates a block diagram of a vehicle terminal.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The terms used in the embodiments are selected, as much as possible, from general terms that are widely used at present while taking into consideration the functions obtained in accordance with the present disclosure, but these terms may be replaced by other terms based on intentions of those skilled in the art, customs, emergency of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including”(or “comprising”) another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

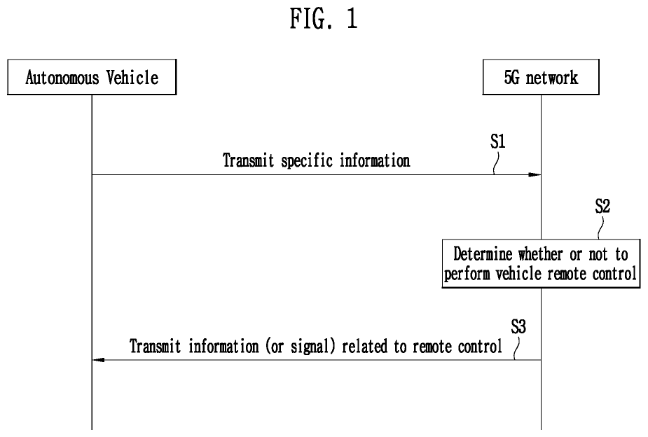

FIG. 1 illustrates an example of a basic operation of an autonomous vehicle and a 5G network in a 5G communication system.

In step S1, the autonomous vehicle transmits specific information to the 5G network which is based on a fifth generation cellular network technology.

The specific information may include information related to autonomous driving.

The information related to autonomous driving may be information that is directly related to vehicle driving control. For example, the information related to autonomous driving may include at least one of object data indicating an object around a vehicle, map data, vehicle state data, vehicle location data, and driving plan data. The information related to autonomous driving may further include, for example, service information required for autonomous driving.

In step S2, the 5G network may determine whether or not to perform vehicle remote control. Here, the 5G network may be connected to a server or a module which performs remote control related to autonomous driving, or may include such a server or module.

In step S3, the 5G network may transmit information (or signals) related to remote control to the autonomous vehicle.

As described above, the information related to remote control may be signals directly applied to the autonomous vehicle, and may further include service information required for autonomous driving. In an embodiment of the present disclosure, the autonomous vehicle may identify whether or not an abnormally congested section has occurred in a road section by receiving traffic information on the road section from a server connected to the 5G network, and may perform driving based on the occurrence of the abnormally congested section. In addition, the autonomous vehicle may provide the information on the abnormally congested section to the outside.

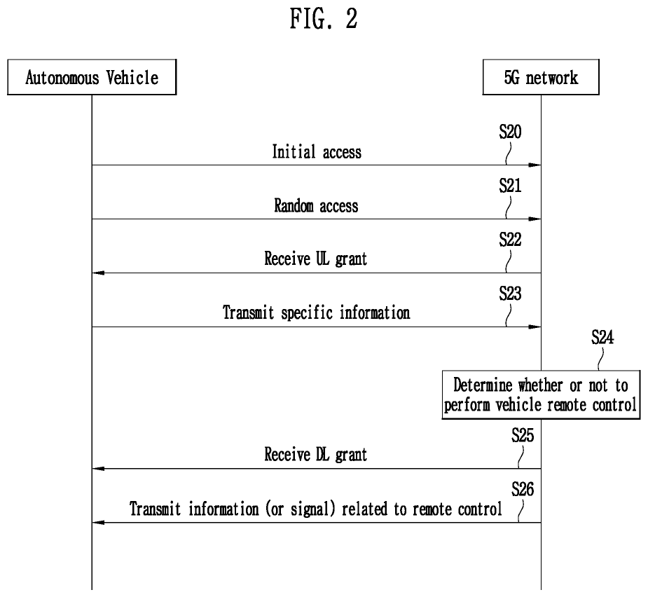

Hereinafter, a process required for 5G communication between an autonomous vehicle and a 5G network (for example, an initial access process between the vehicle and the 5G network) will be schematically described with reference to FIGS. 2 to 6, in order to provide information on an abnormally congested section in accordance with the present disclosure.

FIG. 2 illustrates an example of an application operation of an autonomous vehicle and a 5G network in a 5G communication system.

In step S20, the autonomous vehicle performs an initial access process with the 5G network.

The initial access process includes, for example, a cell search process for the acquisition of a downlink (DL) operation and a process of acquiring system information.

In step S21, the autonomous vehicle performs a random access process with the 5G network.

The random access process includes, for example, preamble transmission and random access response reception processes for the acquisition of uplink (UL) synchronization or the transmission of UL data.

In step S22, the 5G network transmits an UL grant for scheduling the transmission of specific information to the autonomous vehicle (S22).

The reception of the UR grant includes a process of receiving a time and frequency resource schedule for the transmission of UL data to the 5G network.

In step S23, the autonomous vehicle transmits specific information to the 5G network based on the UL grant.

In step S24, the 5G network determines whether or not to perform vehicle remote control.

In step S25, the autonomous vehicle receives a DL grant from the 5G network through a physical downlink control channel in order to receive a response to the specific information.

In step S26, the 5G network transmits information (or signals) related to remote control to the autonomous vehicle based on the DL grant.

It is to be noted that, in FIG. 2, an example in which the initial access process and/or the random access process and the downlink grant reception process of the communication between the autonomous vehicle and the 5G network are combined with each other has been described by way of example via steps S20 to S26, but the present disclosure is not limited thereto.

For example, the initial access process and/or the random access process may be performed through steps S20, S22, S23, S24 and S25. In addition, the initial access process and/or the random access process may be performed through steps S21, S22, S23, S24 and S26.

In addition, a process of combining an AI operation and the downlink grant reception process with each other may be performed through steps S23, S24, S25 and S26.

In addition, it is to be noted that, in FIG. 2, an autonomous vehicle operation has been described by way of example through steps S20 to S26, and the present disclosure is not limited thereto.

For example, an autonomous vehicle operation may be realized by selectively combining steps S20, S21, S22 and S25 with steps S23 and S26. In addition, for example, an autonomous vehicle operation may be composed of steps S21, S22, S23 and S26. In addition, for example, an autonomous vehicle operation may be composed of steps S20, S21, S23 and S26. In addition, for example, an autonomous vehicle operation may be composed of steps S22, S23, S25 and S26.

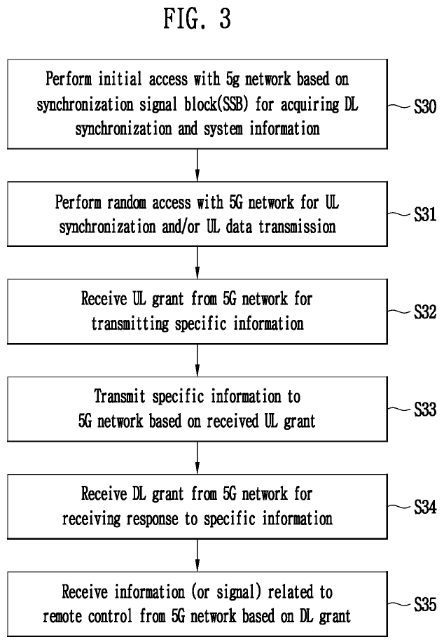

FIGS. 3 to 6 illustrate examples of an autonomous vehicle operation using 5G communication.

First, referring to FIG. 3, in step S30, an autonomous vehicle including an autonomous driving module performs an initial access process with a 5G network based on a synchronization signal block (SSB) to acquire DL synchronization and system information.

In step S31, the autonomous vehicle performs a random access process with the 5G network to acquire UL synchronization and/or to transmit UL data.

In step S32, the autonomous vehicle receives an UL grant from the 5G network in order to transmit specific information.

In step S33, the autonomous vehicle transmits specific information to the 5G network based on the UL grant.

In step S34, the autonomous vehicle receives a DL grant from the 5G network in order to receive a response to the specific information.

In step S35, the autonomous vehicle receives information (or signals) related to remote control from the 5G network based on the DL grant.

A beam management (BM) process may be added to step S30, and a beam failure recovery process related to the transmission of a physical random access channel (PRACH) may be added to step S31. A quasi co-located (QCL) relationship may be added to step S32 with regard to the beam reception direction of a physical downlink control channel (PDCCH). The QCL relationship may also be added to step S33 with regard to the beam transmission direction of a physical uplink control channel (PUCCH) and a physical uplink shared channel (PUSCH).

In addition, the QCL relationship may also be added to step S34 with regard to the beam reception direction of a PDCCH including a DL grant.

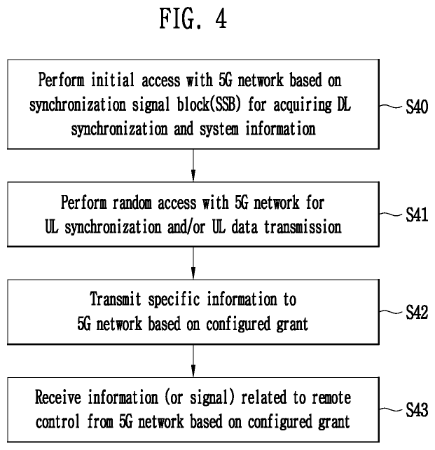

Referring to FIG. 4, in step S40, the autonomous vehicle performs an initial access process with the 5G network based on an SSB to acquire DL synchronization and system information.

In step S41, the autonomous vehicle performs a random access process with the 5G network to acquire UL synchronization and/or to transmit UL data.

In step S42, the autonomous vehicle transmits specific information to the 5G network based on a configured grant.

In step S43, the autonomous vehicle receives information (or signals) related to remote control from the 5G network based on the configured grant.

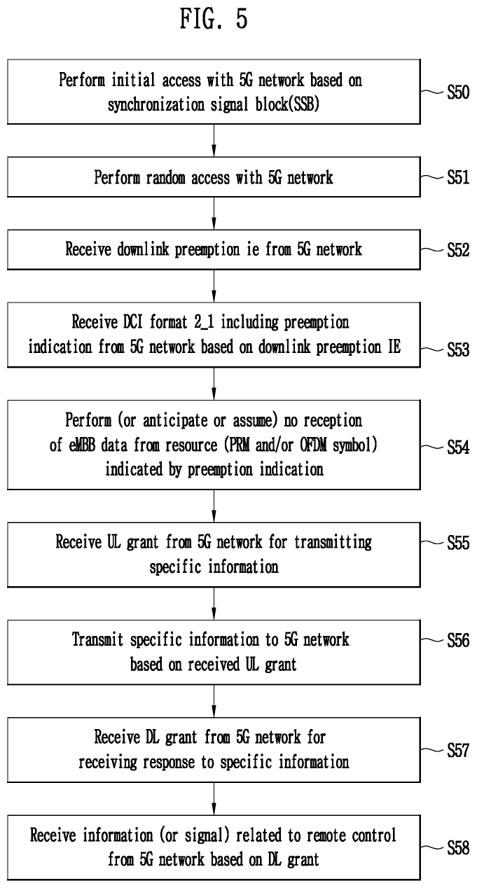

Referring to FIG. 5, in step S50, the autonomous vehicle performs an initial access process with the 5G network based on an SSB to acquire DL synchronization and system information.

In step S51, the autonomous vehicle performs a random access process with the 5G network to acquire UL synchronization and/or to transmit UL data.

In step S52, the autonomous vehicle receives a downlink preemption IE from the 5G network.

In step S53, the autonomous vehicle receives a DCI format 2_1 including a preemption indication from the 5G network based on the downlink preemption IE.

In step S54, the autonomous vehicle does not perform (or anticipate or assume) reception of eMBB data from a resource (PRB and/or OFDM symbols) indicated by the preemption indication.

In step S55, the autonomous vehicle receives an UL grant from the 5G network in order to transmit specific information.

In step S56, the autonomous vehicle transmits specific information to the 5G network based on the UL grant.

In step S57, the autonomous vehicle receives a DL grant from the 5G network in order to receive a response to the specific information.

In step S58, the autonomous vehicle receives information (or signals) related to remote control from the 5G network based on the DL grant.

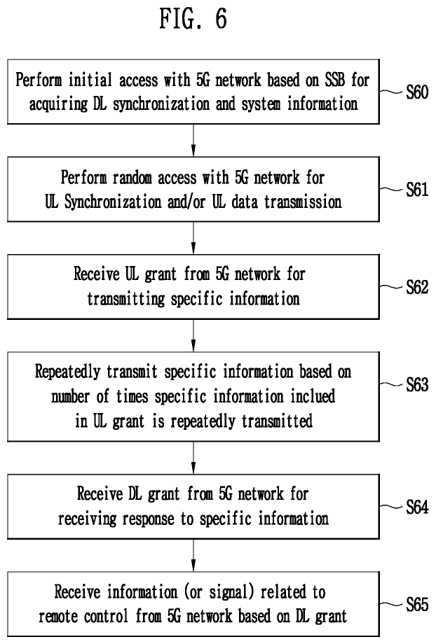

Referring to FIG. 6, in step S60, the autonomous vehicle performs an initial access process with the 5G network based on an SSB to acquire DL synchronization and system information.

In step S61, the autonomous vehicle performs a random access process with the 5G network in order to acquire UL synchronization and/or to transmit UL data.

In step S62, the autonomous vehicle receives an UL grant from the 5G network in order to transmit specific information.

In step S63, the UL grant includes information on the number of times the transmission of specific information is repeated, and the specific information is repeatedly transmitted based on the information on the number of repetition times.

The autonomous vehicle transmits specific information to the 5G network based on the UL grant.

The repetitive transmission of the specific information may be performed through frequency hopping. First transmission of the specific information may be implemented from a first frequency resource, and second transmission of the specific information may be implemented from a second frequency resource.

The specific information may be transmitted through the narrowband of six resource blocks or one resource block.

In step S64, the autonomous vehicle receives a DL grant from the 5G network in order to receive a response to the specific information.

In step S65, the autonomous vehicle receives information (or signals) related to remote control from the 5G network based on the DL grant.

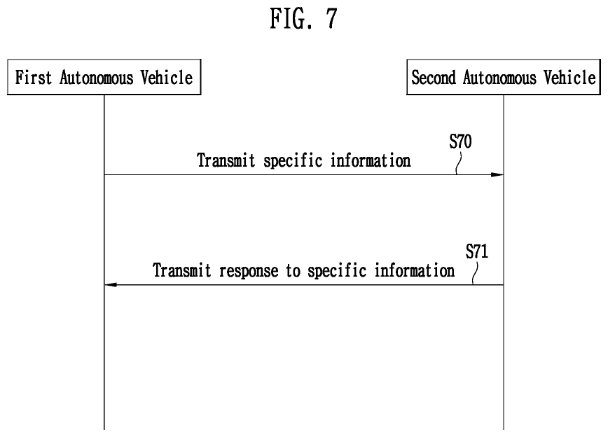

FIG. 7 illustrates an example of a basic operation of a first autonomous vehicle and a second autonomous vehicle in a 5G communication system.

In step S70, the first autonomous vehicle transmits specific information to the second autonomous vehicle.

The specific information may include information related to autonomous driving. The information related to autonomous driving may be information directly related to vehicle driving control. For example, the information related to autonomous driving may include at least one of object data indicating an object around a vehicle, map data, vehicle state data, vehicle location data, vehicle speed data, and driving plan data. The information related to autonomous driving may further include, for example, service information required for autonomous driving.

In step S71, the second autonomous vehicle may transmit a response to the specific information to the first autonomous vehicle.

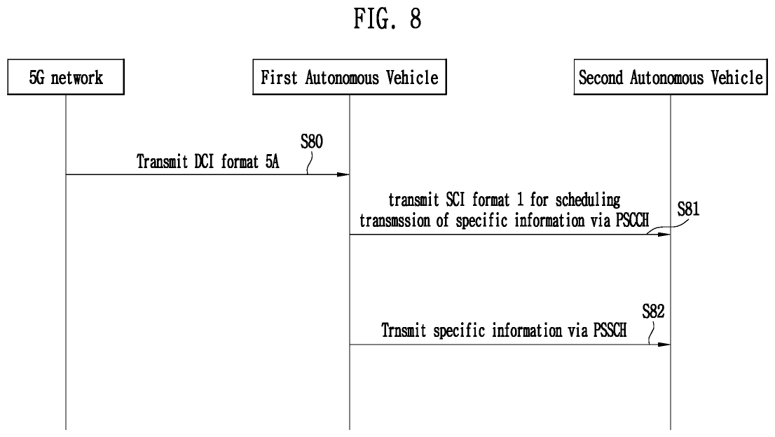

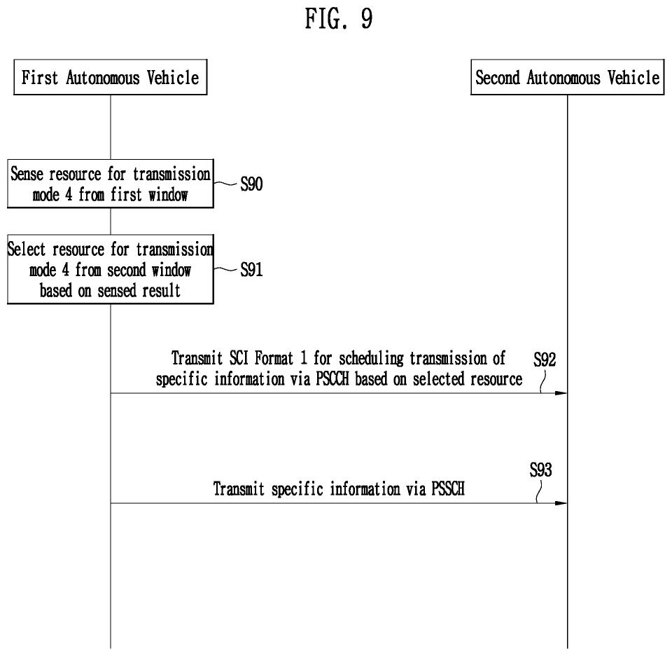

Hereinafter, a process required for 5G communication between a first autonomous vehicle and a second autonomous vehicle (for example, a resource allocation method for vehicle-to-vehicle communication) will be schematically described with reference to FIGS. 8 and 9, in order to provide information on an abnormally congested section in accordance with the present disclosure.

FIG. 8 illustrates an embodiment in which a 5G network is directly concerned in signal transmission and reception resource allocation in 5G communication between autonomous vehicles.

In step S80, the 5G network may transmit a downlink control information (DCI) format 5A to a first autonomous vehicle. Specifically, the 5G network may transmit the DCI format 5A to the first autonomous vehicle for the scheduling of a transmission mode 3. The transmission mode 3 may be referred to as scheduled resource allocation, and in the transmission mode 3, the 5G network may perform, on the autonomous vehicle, resource scheduling using downlink control information (DCI), and the autonomous vehicle may perform V2V communication with another autonomous vehicle according to the resource scheduling.

In step S81, the first autonomous vehicle may transmit a sidelink control information (SCI) format 1 for the scheduling of the transmission of specific information to a second autonomous vehicle via a physical sidelink control channel (PSCCH). The SCI format 1 includes, for example, a priority, resource reservation, frequency resource positions for initial transmission and re-transmission (i.e., the number of bits may change according to the number of sidelink sub-channels), a time gap between initial transmission and re-transmission, a modulation and coding scheme (MCS), and a re-transmission index.

In step S82, the first autonomous vehicle may transmit specific information to the second autonomous vehicle via a physical sidelink shard channel (PSSCH).

FIG. 9 illustrates an embodiment in which a 5G network is indirectly concerned in signal transmission and reception resource allocation in 5G communication between autonomous vehicles.

In step S90, a first autonomous vehicle may sense a resource for a transmission mode 4 in a first window. The first window may be a sensing window, and the transmission mode 4 may be applied to a vehicle to everything (V2X) operation. A vehicle or a terminal may directly select a resource from the window selected through a sensing process and then may perform a V2X operation.

In step S91, the first autonomous vehicle may select the resource for the transmission mode 4 in a second window based on the sensed result in step S90.

In step S92, the first autonomous vehicle may transmit an SCI format 1 for the scheduling of the transmission of specific information to a second autonomous vehicle via a PSCCH based on the resource selected in step S91.

In step S93, the first autonomous vehicle may transmit specific information to the second autonomous vehicle via the PSSCH.

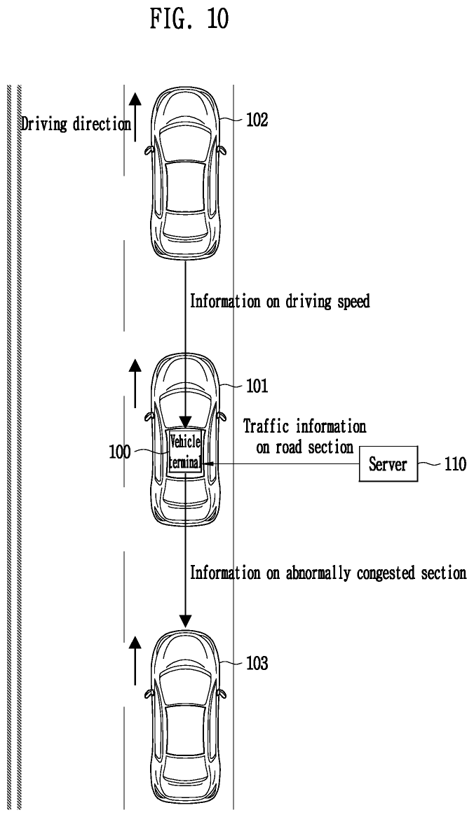

The 5G communication technology described above may be applied in combination with any of the methods proposed by the following description with reference to FIGS. 10 to 16, or may be supplemented to specify or clarify technical features of the methods proposed herein.

In addition, herein, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a vehicle equipped with an autonomous driving device which is capable of recognizing the environment around the vehicle and the vehicle condition and thus, controlling the driving of the vehicle. The autonomous vehicle may also be referred to as a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive along a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

One or more of a vehicle, a vehicle terminal, and an autonomous vehicle disclosed here may be connected to or converged with an artificial intelligence module, an unmanned aerial vehicle (UAV), a robot, an augmented reality (AR) device, a virtual reality (VR) device, and a 5G service device, for example.

For example, an autonomous vehicle may be operated in connection with at least one artificial intelligence module or robot included in the vehicle.

For example, a vehicle may interact with at least one robot. The robot may be an autonomous mobile robot (AMR) that may move autonomously. The mobile robot is freely movable via an autonomous movement function thereof, and may move to avoid an obstacle through the use of multiple sensors required for avoiding an obstacle during movement. The mobile robot may be a flying robot (for example, a drone) equipped with a flight device. The mobile robot may be a wheeled robot that has at least one wheel and moves via rotation of the wheel. The mobile robot may be a legged robot that has at least one leg and moves using the leg.

A robot may function as a device that supplements user convenience. For example, a robot may function to carry a baggage loaded in a vehicle to a user's final destination. For example, a robot may function to guide a user who got off a vehicle the way to a final destination. For example, a robot may function to transport a user who got off a vehicle to a final destination.

At least one electronic device included in a vehicle may perform communication with a robot via a communication device.

The at least one electronic device included in the vehicle may include a software module or a hardware module (hereinafter referred to as an artificial intelligence module) that realizes artificial intelligence (AI). The at least one electronic device included in the vehicle may input acquired data to the artificial intelligence module and may use data output from the artificial intelligence module.

The artificial intelligence module may perform machine learning on the input data using at least one artificial neural network (ANN). The artificial intelligence module may output driving plan data via the machine learning on the input data.

The at least one electronic device included in the vehicle may generate a control signal based on the data output from the artificial intelligence module.

In some embodiments, the at least one electronic device included in the vehicle may receive data processed by artificial intelligence from an external device through the communication device. The at least one electronic device included in the vehicle may generate a control signal based on the data processed by artificial intelligence.

FIG. 10 is a view illustrating an example of an operation of a vehicle terminal.

A vehicle terminal 100 may be included in a vehicle 101 which drives a road section illustrated in FIG. 10. Vehicle 101 may be an autonomous vehicle in accordance with the present disclosure.

Vehicle terminal 100 may acquire traffic information on the road section from a server 110. Specifically, vehicle terminal 100 may acquire traffic information indicating whether vehicle traffic is smooth or is congested in the road section from server 110.

Vehicle terminal 100 may acquire information on the driving speed of a peripheral vehicle 102 which drives in front of vehicle 101 from peripheral vehicle 102.

Vehicle terminal 100 may identify whether or not an abnormally congested section has occurred in the road section based on the traffic information on the road section and the driving speed of peripheral vehicle 102. For example, vehicle terminal 100 may determine that an abnormally congested section has occurred near peripheral vehicle 102 when determining that the traffic information on the road section is “smooth” but the driving speed of peripheral vehicle 102 is slow.

Vehicle terminal 100 may provide information on an abnormally congested section when the abnormally congested section has occurred in the road section. Specifically, vehicle terminal 100 may transmit information indicating that the abnormally congested section has occurred in front of vehicle 101 to a peripheral vehicle 103 which drives in the rear of vehicle 101. As a result, peripheral vehicle 103 may identify information indicating that the abnormally congested section has occurred in the road section in front of the vehicle.

Accordingly, vehicle terminal 100 may more quickly identify whether or not the abnormally congested section has occurred in the road section. For example, the traffic information on the road section provided from the server may be updated at a time interval of 30 minutes or 1 hour. However, an abnormally congested section may occur due to the occurrence of an event such as accidents, drunk driving control, a group of successive vehicles, constructions, and emergency vehicle traffic, but the traffic information provided from the server has difficulty in reflecting the occurrence of such an event in real time. On the other hand, vehicle terminal 100 may more quickly grasp whether or not an abnormally congested section has occurred based on the traffic information on the road section and the driving speed of the peripheral vehicle, and may output the grasped result to the outside so as to contribute to smooth vehicle traffic. For example, when identifying information indicating that the abnormally congested section has occurred in front of the vehicle, peripheral vehicle 103 may change the lane to the left and drive the road.

In addition, since vehicle 101 may be an autonomous vehicle, vehicle 101 may correct a driving route so as to avoid the abnormally congested section, and may drive the road along a corrected driving route. For example, vehicle 101 may identify information on the abnormally congested section which has occurred in front of the vehicle, and may change the lane to the left and drive the road.

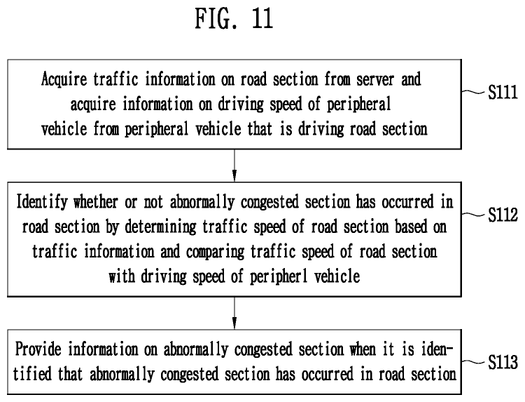

FIG. 11 is a flowchart of an operation method of a vehicle terminal.

In step S111, vehicle terminal 100 may acquire traffic information on a road section from a server and may acquire information on the driving speed of a peripheral vehicle from the peripheral vehicle which drives the road section.

Vehicle terminal 100 may acquire traffic information on the road section via communication with the server. For example, vehicle terminal 100 may acquire traffic information on the road section from the server via wireless communication between a vehicle and an infrastructure (V2I) or wireless communication between a vehicle and a network (V2N).

The server may collect information on the movement of vehicles over a nationwide road network, and may provide general information on the traffic situation of the road section based on the collected information. The traffic information on the road section may include information indicating the degree by which vehicle traffic is smooth in the road section. For example, the traffic information on the road section may include information indicating that the road section is in any one of a smooth state, a delayed state, and a congested state. Further, the traffic information on the road section may include information on the speed limit of the road section. For example, the traffic information on the road section may include information indicating that the speed limit of the road section is 60 km/h.

Vehicle terminal 100 may acquire the traffic information on the road section from a navigation system in vehicle 101.

Vehicle terminal 100 may acquire information on the driving speed of a peripheral vehicle via communication with the peripheral vehicle. For example, vehicle terminal 100 may acquire information on the driving speed of a peripheral vehicle from the peripheral vehicle via vehicle-to-vehicle (V2V) wireless communication.

Vehicle terminal 100 may perform target classification via communication with peripheral vehicles, and may monitor the state of the peripheral vehicles. For example, vehicle terminal 100 may monitor, for example, the positions of the peripheral vehicles, the driving direction of the peripheral vehicles, and the speeds of the peripheral vehicles.

Vehicle terminal 100 may perform an access process with a 5G network, and may acquire traffic information from a server through the 5G network and may further acquire information on the driving speed of a peripheral vehicle from the peripheral vehicle through the 5G network. For example, vehicle terminal 100 may perform an access process with the 5G network illustrated in FIGS. 1 to 9.

In step S112, vehicle terminal 100 may identify whether or not an abnormally congested section has occurred in the road section by determining the traffic speed of the road section based on the traffic information and comparing the traffic speed of the road section with the driving speed of the peripheral vehicle.

Vehicle terminal 100 may determine the traffic speed of the road section based on the traffic information on the road section. The traffic speed may be the speed indicating the degree by which vehicle traffic is smooth in the road section. Specifically, vehicle terminal 100 may identify or determine the traffic speed of the road section based on at least one of information indicating the degree by which vehicle traffic is smooth and information on the speed limit of the road section. For example, vehicle terminal 100 may determine the traffic speed of the road section to 50 km/h when vehicle traffic is smooth in the road section and the speed limit of the road section is 60 km/h.

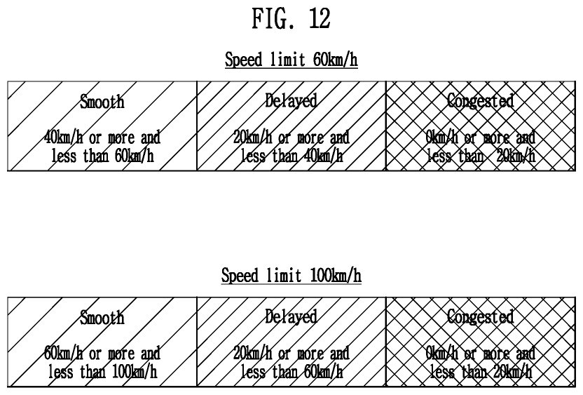

FIG. 12 illustrates an embodiment in which a vehicle terminal determines the traffic speed of a road section.

Vehicle terminal 100 may divide the traffic state of the road section into three states including a smooth state, a delayed state, and a congested state, and may determine the traffic speed for each traffic state according to the speed limit of the road section.

Referring to FIG. 12, when the speed limit of the road section is 60 km/h and vehicle traffic is in a smooth state, vehicle terminal 100 may determine the traffic speed of the road section to a speed within a range of 40 km/h or more and less than 60 km/h. When the speed limit of the road section is 60 km/h and vehicle traffic is in a delayed state, vehicle terminal 100 may determine the traffic speed of the road section to a speed within a range of 20 km/h or more and less than 40 km/h. When the speed limit of the road section is 60 km/h and vehicle traffic is in a congested state, vehicle terminal 100 may determine the traffic speed of the road section to a speed of less than 20 km/h. In addition, when the speed limit of the road section is 60 km/h and vehicle traffic is in a smooth state, vehicle terminal 100 may determine the traffic speed of the road section to 50 km/h which is the average of the range of 40 km/h and less than 60 km/h.

Similarly, when the speed limit of the road section is 100 km/h and vehicle traffic is in a smooth state, vehicle terminal 100 may determine the traffic speed of the road section to a speed within a range of 60 km/h or more and less than 100 km/h. In addition, when the speed limit of the road section is 100 km/h and vehicle traffic is in a delayed state, vehicle terminal 100 may determine the traffic speed of the road section to 20 km/h which is the minimum speed within a range of 20 km/h or more and less than 60 km/h.

Referring again to FIG. 11, vehicle terminal 100 may identify whether or not an abnormally congested section has occurred in the road section by comparing the traffic speed of the road section with the driving speed of the peripheral vehicle.

In one example, vehicle terminal 100 may identify that an abnormally congested section has occurred in the road section when the driving speed of the peripheral vehicle is less than the traffic speed of the road section. For example, when the traffic speed of the road section is within a range of 60 km/h or more and less than 100 km/h and the driving speed of the peripheral vehicle is 40 km/h, vehicle terminal 100 may identify that an abnormally congested section has occurred near the front of the peripheral vehicle.

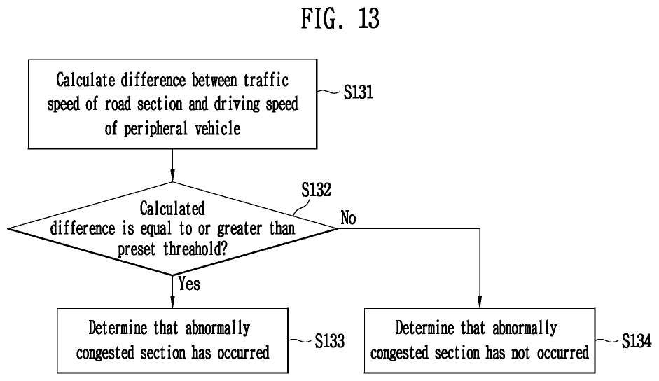

In another example, vehicle terminal 100 may identify that an abnormally congested section has occurred in the road section when the difference between the traffic speed of the road section and the driving speed of the peripheral vehicle is greater than a preset threshold. A concrete example will be described below with reference to FIG. 13. The threshold has been described as being preset in the embodiment, but is not limited thereto, and may be identified or determined by vehicle terminal 100 or may be provided from an external server. Identification of information related to the threshold by the vehicle terminal in the embodiment may be performed based on checked information from at least one sensor inside the vehicle.

FIG. 13 illustrates an embodiment in which a vehicle terminal identifies whether or not an abnormally congested section has occurred in a road section.

In step S131, vehicle terminal 100 may calculate the difference between the traffic speed of a road section and the driving speed of a peripheral vehicle. For example, when the traffic speed of the road section is 40 km/h and the driving speed of the peripheral vehicle is 30 km/h, vehicle terminal 100 may calculate the difference between the traffic speed of the road section and the driving speed of the peripheral vehicle as 10 km/h.

In step S132, vehicle terminal 100 may determine whether or not the difference calculated in step S131 is equal to or greater than a preset threshold. Here, the preset threshold may be determined based on the speed limit of the road section. For example, the preset threshold may be determined to one third of the speed limit of the road section. When the speed limit of the road section is 60 km/h, the preset threshold may be 20 km/h.

In step S133, vehicle terminal 100 may determine that an abnormally congested section has occurred when it is determined in step S132 that the calculated difference is equal to or greater than the preset threshold. For example, when the speed limit of the road section is 60 km/h, the traffic speed is 40 km, and the driving speed of the peripheral vehicle is 10 km, vehicle terminal 100 may determine that an abnormally congested section has occurred in the road section since the difference between the traffic speed and the driving speed is greater than the preset threshold of 20 km/h.

In step S134, vehicle terminal 100 may determine that an abnormally congested section has not occurred when it is determined in step S132 that the calculated difference is less than the preset threshold. For example, when the speed limit of the road section is 60 km/h, the traffic speed is 40 km, and the driving speed of the peripheral vehicle is 30 km, vehicle terminal 100 may determine that an abnormally congested section has not occurred in the road section since the difference between the traffic speed and the driving speed is less than the preset threshold of 20 km/h.

Referring again to FIG. 11, vehicle terminal 100 may identify whether or not an abnormally congested section has occurred in the road section for each lane. Specifically, vehicle terminal 100 may identify whether or not an abnormally congested section has occurred in the lane within the road section in which the peripheral vehicle is driving. For example, when the peripheral vehicle drives in a first lane within the road section, vehicle terminal 100 may identify whether or not an abnormally congested section has occurred in the first lane based on traffic information on the first lane within the road section and the driving speed of the peripheral vehicle.

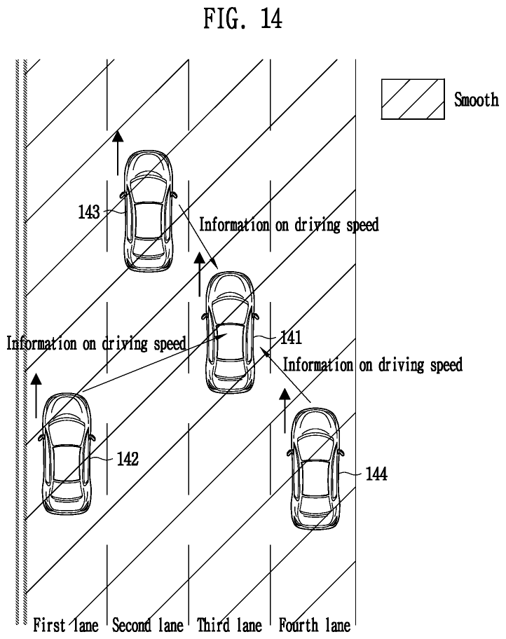

FIG. 14 illustrates an embodiment in which a vehicle identifies, for each lane, whether or not an abnormally congested section has occurred in a road section.

A vehicle 141 may drive in a third lane within a road section illustrated in FIG. 14, and may identify whether or not an abnormally congested section has occurred in the road section.

In particular, vehicle 141 may identify whether or not an abnormally congested section has occurred for each of four lanes within the road section. Specifically, vehicle 141 may identify whether or not an abnormally congested section has occurred in each lane within the road section based on information on the speed of a peripheral vehicle which is driving in each lane within the road section and traffic information on the road section.

As illustrated in FIG. 14, vehicle 141 may receive information indicating that vehicle traffic in the road section is in a smooth state. Vehicle 141 may receive information on the driving speed of a peripheral vehicle 142 which is driving in a first lane from peripheral vehicle 142. Subsequently, vehicle 141 may identify whether or not an abnormally congested section has occurred in the first lane based on information on the traffic state of the road section and information on the driving speed of peripheral vehicle 142. For example, when it is determined that vehicle traffic in the road section is in a smooth state but peripheral vehicle 142 is not driving smoothly, vehicle 141 may determine that an abnormally congested section has occurred in the first lane in front of peripheral vehicle 142.

Vehicle 141 may identify whether or not an abnormally congested section has occurred in a second lane based on information on the traffic state of the road section and information on the driving speed of a peripheral vehicle 143. For example, when it is determined that vehicle traffic in the road section is in a smooth state and peripheral vehicle 143 is driving smoothly, vehicle 141 may determine that an abnormally congested section has not occurred near peripheral vehicle 143.

Vehicle 141 may identify whether or not an abnormally congested section has occurred in a fourth lane based on information on the traffic state of the road section and information on the driving speed of a peripheral vehicle 144. For example, when it is determined that vehicle traffic in the road section is in a congested state and the driving speed of peripheral vehicle 144 reflects a smooth state, vehicle 141 may determine that an abnormally congested section has occurred near peripheral vehicle 144 but the congested traffic state has been resolved near peripheral vehicle 144.

It has been illustrated in FIG. 14 that vehicle traffic in all lanes within the road section is in a smooth state, but the respective lanes within the road section may exhibit different traffic states. For example, the first lane within the road section may exhibit a smooth traffic state, whereas the third lane within the road section may exhibit a congested traffic state.

Referring again to FIG. 11, in step S113, vehicle terminal 100 may provide information on an abnormally congested section when it is identified in step S112 that the abnormally congested section has occurred.

In one example, vehicle terminal 100 may provide information on an abnormally congested section to a peripheral vehicle. For example, vehicle terminal 100 may transmit information indicating that an abnormally congested section has occurred in front of a first vehicle to a second vehicle located in the rear of the first vehicle. In one example, vehicle terminal 100 may transmit information on the abnormally congested section to the peripheral vehicle via a decentralized environmental notification message (DENM) depending on V2X communication. In particular, vehicle terminal 100 may provide information on the abnormally congested section using a forward traffic jam warning of the DENM. In another example, vehicle terminal 100 may provide information on the abnormally congested section by adding a type event item in a roadside alert (RSA) depending on V2X communication. In a further example, vehicle terminal 100 may provide information on the abnormally congested section using a reserve area in a traveler information message (TIM) depending on V2X communication.

In another example, vehicle terminal 100 may provide information on the abnormally congested section to a server. For example, vehicle terminal 100 may provide information on the abnormally congested section to the server using a message for sharing between peripheral vehicles. In addition, the server may update traffic information on the road section based on information on the abnormally congested section. For example, the server has determined that vehicle traffic in the road section is in a smooth state, but may change the traffic state of the road section to a congested state based on information on the abnormally congested section. In addition, the server may transmit information on the abnormally congested section to vehicles in the road section.

When vehicle terminal 100 provides information on the abnormally congested section to the peripheral vehicle or the server, vehicle terminal 100 may further provide information on the duration time of the occurrence of the abnormally congested section to the peripheral vehicle or the server. In this case, the peripheral vehicle or the server may extend the duration time of the occurrence of the abnormally congested section when receiving information on the same abnormally congested section before the duration time of the occurrence of the abnormally congested section has passed. However, the server or the peripheral vehicle may maintain the duration time of the occurrence of the abnormally congested section when repeatedly receiving information on the same abnormally congested section for a relatively short time period. In addition, the peripheral vehicle may request the server information on the abnormally congested section when the duration time of an event has passed.

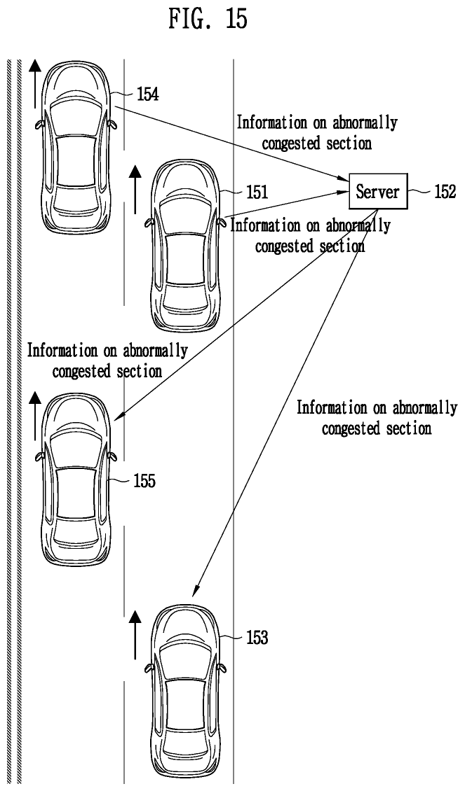

FIG. 15 illustrates an embodiment in which a vehicle transmits information on an abnormally congested section to a server.

A vehicle 151 may transmit information on an abnormally congested section to a server 152 when it is identified that the abnormally congested section has occurred in a road section illustrated in FIG. 15. Specifically, vehicle 151 may transmit, to server 152, information indicating that the abnormally congested section has occurred in front of vehicle 151 in a second lane in which vehicle 151 is driving.

Server 152 may update traffic information on the road section based on information on the abnormally congested section from vehicle 151. For example, server 152 may update the traffic state of the road section illustrated in FIG. 15 from a smooth state to a congested state.

Server 152 may transmit information on the abnormally congested section from vehicle 151 to a vehicle 153. In other words, server 152 may transmit, to vehicle 153, information indicating that the abnormally congested section has occurred in front of vehicle 152.

Similarly, server 152 may receive information indicating that the abnormally congested section has occurred in front of a vehicle 154 from vehicle 154, and may transmit information on the abnormally congested section to a vehicle 155.

Accordingly, since information indicating that the abnormally congested section has occurred may be provided to vehicles via server 152, a broader traffic information transmission system may be established. For example, since the communication range between vehicles is limited, whereas the communication range between a vehicle and a server is relatively wide, information indicating that the abnormally congested section has occurred may be transferred to vehicles within a broader area via server 152.

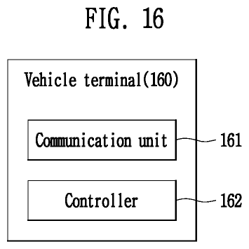

FIG. 16 illustrates a block diagram of a vehicle terminal.

A vehicle terminal 160 may be a device that is disposed inside a vehicle to assist a driver in driving the vehicle. In one embodiment, vehicle terminal 160 may include a communication unit 161 and a controller 162. In FIG. 16, only components of vehicle terminal 160 associated with the present embodiment are illustrated. Thus, it will be understood by those skilled in the art that the vehicle terminal may include common components other than the components illustrated in FIG. 16.

Communication unit 161 may communicate with an external electronic device. The external electronic device may be a peripheral vehicle, may be a server, or may be an infrastructure such as a roadside unit (RSU). Communication unit 161 may communicate with an external vehicle or a server based on vehicle-to-vehicle (V2V) wireless communication or vehicle-to-network (V2N) wireless communication.

In addition, a communication technology used by communication unit 161 may be, for example, a global system for mobile communication (GSM), a code division multi-access (CDMA), long term evolution (LTE), 5G, wireless LAN (WLAN), wireless-fidelity (Wi-Fi), bluetooth™, radio frequency identification (RFID), infrared data association (IrDA), ZigBee, or near field communication (NFC).

Controller 162 may control a general operation of vehicle terminal 160 and may process data and signals. Controller 162 may be configured as at least one hardware unit. In addition, controller 162 may be operated by one or more software models which are generated by executing a program code stored in a memory.

Controller 162 may acquire traffic information on a road section from a server through communication unit 161, and may acquire information on the driving speed of a peripheral vehicle from the peripheral vehicle which is driving the road section through communication unit 161.

Controller 162 may determine the traffic speed of the road section based on the traffic information, and may identify whether or not an abnormally congested section has occurred in the road section by comparing the traffic speed of the road section with the driving speed of the peripheral vehicle.

Controller 162 may identify whether or not an abnormally congested section has occurred in a lane within the road section in which the peripheral vehicle is driving.

Controller 162 may determine that an abnormally congested section has occurred in the road section when the difference between the traffic speed of the road section and the driving speed of the peripheral vehicle is greater than a preset threshold.

Controller 162 may provide information on the abnormally congested section through communication unit 161 when determining that the abnormally congested section has occurred in the road section. Controller 162 may provide information on the abnormally congested section to at least one of other peripheral vehicles which are driving the road section or the server.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer readable recording medium as computer readable codes or program commands which may be executed by the processor. Here, the computer readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer readable recording medium may be dispersed to computer systems connected by a network so that computer readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

What is claimed is:

1. An operation method of a vehicle terminal comprising:
acquiring traffic information on a road section from a server and acquiring information on a driving speed of a peripheral vehicle from the peripheral vehicle that is driving the road section;
identifying whether or not an abnormally congested section has occurred in the road section by determining a traffic speed of the road section based on the traffic information and comparing the traffic speed of the road section with the driving speed of the peripheral vehicle; and
providing information on the abnormally congested section when it is identified that the abnormally congested section has occurred in the road section.

2. The method of claim 1, wherein the traffic information includes at least one of information indicating a degree by which vehicle traffic is smooth in the road section and information on a speed limit of the road section, and
wherein the identifying includes determining the traffic speed of the road section based on the information indicating the degree by which vehicle traffic is smooth in the road section and the information on the speed limit of the road section.

3. The method of claim 1, wherein the identifying includes identifying that the abnormally congested section has occurred in the road section when a difference between the traffic speed of the road section and the driving speed of the peripheral vehicle is greater than a threshold.

4. The method of claim 3, wherein the threshold is identified based on the speed limit of the road section.

5. The method of claim 1, wherein the providing includes providing the information on the abnormally congested section to at least one of other peripheral vehicles that are driving the road section and the server.

6. The method of claim 1, wherein the identifying includes identifying whether or not the abnormally congested section has occurred in a lane within the road section in which the peripheral vehicle is driving based on at least a part of the acquired information.

7. The method of claim 1, wherein the acquiring or the providing is performed based on vehicle-to-vehicle (V2V) wireless communication or vehicle-to-network (V2N) wireless communication.

8. The method of claim 1, further comprising performing an access process with a 5G network by the vehicle terminal, and
wherein the acquiring includes acquiring the traffic information from the server through the 5G network and acquiring the information on the driving speed of the peripheral vehicle from the peripheral vehicle through the 5G network.

9. A vehicle terminal comprising:
a communication unit; and
a controller configured to acquire traffic information on a road section from a server and acquire information on a driving speed of a peripheral vehicle from the peripheral vehicle that is driving the road section through the communication unit, to identify whether or not an abnormally congested section has occurred in the road section by determining a traffic speed of the road section based on the traffic information and comparing the traffic speed of the road section with the driving speed of the peripheral vehicle, and to provide information on the abnormally congested section through the communication unit when it is identified that the abnormally congested section has occurred in the road section.

10. The vehicle terminal of claim 9, wherein the traffic information includes at least one of information indicating a degree by which vehicle traffic is smooth in the road section and information on a speed limit of the road section, and
wherein the controller determines the traffic speed of the road section based on the information indicating the degree by which vehicle traffic is smooth in the road section and the information on the speed limit of the road section.

11. The vehicle terminal of claim 9, wherein the controller identifies that the abnormally congested section has occurred in the road section when a difference between the traffic speed of the road section and the driving speed of the peripheral vehicle is greater than a preset threshold.

12. The vehicle terminal of claim 11, wherein the threshold is determined based on the speed limit of the road section.

13. The vehicle terminal of claim 11, wherein the controller provides the information on the abnormally congested section to at least one of other peripheral vehicles that are driving the road section and the server through the communication unit.

14. The vehicle terminal of claim 9, wherein the controller identifies whether or not the abnormally congested section has occurred in a lane within the road section in which the peripheral vehicle is driving based on at least a part of the acquired information.

15. The vehicle terminal of claim 9, wherein the communication unit performs vehicle-to-vehicle (V2V) wireless communication or vehicle-to-network (V2N) wireless communication.

16. The vehicle terminal of claim 9, wherein the controller performs an access process with a 5G network through the communication unit, acquires the traffic information from the server through the 5G network, and acquires the information on the driving speed of the peripheral vehicle from the peripheral vehicle through the 5G network.

17. A computer readable non-volatile recording medium storing a program for executing the method of claim 1.
